(19) United States
(12) Patent Application Publication
(10) Pub. No.: US 2025/0164237 A1
(43) Pub. Date: May 22, 2025

(54) METHOD OF IDENTIFICATION AND DETECTION OF OBJECTS VIA INFRARED REFLECTANCE

(71) Applicant: Universal City Studios LLC, Universal City, CA (US)

(72) Inventors: Eric To Chan, Kissimme, FL (US); Aaron Chandler Jeromin, Winter Garden, FL (US)

(21) Appl. No.: 18/954,088

(22) Filed: Nov. 20, 2024

Related U.S. Application Data
(60) Provisional application No. 63/601,544, filed on Nov. 21, 2023.

(51) Int. Cl. G01B 11/24

(52) U.S. Cl. CPC G01B 11/24

(57) ABSTRACT

In an embodiment, an object identification and detection system include an infrared reflectance assembly. The object identification and detection system include one or more infrared light sources and one or more sensors. The light is reflected from the object, and the one or more sensors detect light indicative of the reflected light and generate sensor data. A control system, coupled to the infrared reflectance assembly controls the one or more infrared light sources to illuminate a one transparent object. The control system also receives the sensor data from the one or more sensors and determines a characteristic of the object based on the sensor data. Further, the control system transmits a signal to activate a special effect based on the characteristic.

### CROSS-REFERENCE TO RELATED APPLICATION

This application claims priority from and the benefit of U.S. Provisional Application Ser. No. 63/601,544, entitled “METHOD OF IDENTIFICATION AND DETECTION OF OBJECTS VIA INFRARED REFLECTANCE”, filed Nov. 21, 2023, which is hereby incorporated by reference in its entirety.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

The subject matter disclosed herein relates to the field of interactive and visual guest experiences. More specifically, embodiments of the present disclosure relate to systems and methods for identifying and detecting of objects via infrared reflectance.

Various amusement rides, exhibits, and demonstrations have been created to provide guests with unique interactive, motion, and visual experiences. Such experiences may be designed to provide enhancement to everyday activities to create a fantastical environment. In various rides and exhibits, guest experiences may be enhanced by employing certain interactive visual features within the rides and exhibits. However, some interactive visual features may be costly and ill-suited for incorporation into personalized interactions that guests may directly watch, touch, smell, and taste.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, an object identification and detection system is provided that includes an infrared reflectance assembly. The object identification and detection system includes one or more infrared light sources and one or more sensors. The light is reflected from the object, and the one or more sensors detect light indicative of the reflected light and generate sensor data. A control system, coupled to the infrared reflectance assembly controls the one or more infrared light sources to illuminate the object. The control system also receives the sensor data from the one or more sensors and determines a characteristic of the object based on the sensor data. Further, the control system transmits a signal to activate a special effect based on the characteristic.

In an embodiment, a method of operating an object identification and detection system is provided. The method includes controlling, via a control system, one or more infrared light sources and illuminating, via the one or more infrared light sources, an object. The method also includes receiving, via the control system, sensor data from one or more sensors and determining, via the control system, a characteristic of the object based on the sensor data. Further, the method includes transmitting, via the control system, a signal to activate a special effect based on the characteristic.

In an embodiment, an object identification and detection system is provided that includes an infrared reflectance assembly. The object identification and detection system include one or more infrared light sources and one or more sensors. The light is reflected from the object, and the one or more sensors detect light indicative of the reflected light and generate sensor data. A control system, coupled to the infrared reflectance assembly controls the one or more infrared light sources to illuminate the object. The control system also receives the sensor data from the one or more sensors and determines a characteristic of the object based on the sensor data. Further, the control system transmits a signal to activate a special effect based on the characteristic. The object identification and detection system also include a special effect system. The special effect system receives the signal from the control system coupled to the infrared reflectance assembly and selects, via one or more processors, the special effect by using a post-processing algorithm based on a comparison of the characteristic of the object with historical object data and/or a tolerance level. The special effect system activates the special effect based on the selection and generates imagery on or near the object.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a food and beverage venue that includes an object identification and detection system, in accordance with embodiments described herein;

FIG. 2 is a block diagram of an object identification and detection system, in accordance with embodiments described herein;

FIG. 3 is a schematic illustration of an object interacting with the object identification and detection system, in accordance with embodiments described herein;

FIG. 4 is a schematic illustration of an object interacting with the object identification and detection system, in accordance with embodiments described herein;

FIG. 5A is a schematic illustration of an object interacting with the object identification and detection system, in accordance with embodiments described herein;

FIG. 5B is a schematic illustration of an object interacting with the object identification and detection system, in accordance with embodiments described herein;

FIG. 6A is a schematic illustration of an object interacting with the object identification and detection system, in accordance with embodiments described herein;

FIG. 6B is a schematic illustration of an object interacting with the object identification and detection system, in accordance with embodiments described herein;

FIG. 6C is a schematic illustration of an object interacting with the object identification and detection system, in accordance with embodiments described herein; and

FIG. 7 is a flow diagram of a method to control an object identification and detection system, in accordance with embodiments described herein.

### DETAILED DESCRIPTION

One or more specific embodiments will be described below. In an effort to provide a concise description of these embodiments, not all features of an actual implementation are described in the specification. It should be appreciated that, in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It is now recognized that food and beverage venues in amusement parks may lack interactive components that may provide guests with enjoyment. For example, food and beverage venues may provide guests with themed libations (e.g., beverages, drinks, alcoholic beverages) that are premade or prepared before serving. However, certain types of food and beverage effects may be more immersive if the effect is part of a cooking or mixing experience (e.g., potions, secret recipes, magic spells). Inclusion of effects as part of a food and beverage preparation experience may be challenging.

Provided herein is an identification and detection system that may be used in conjunction with or as part of a refreshments (e.g., food and/or beverage) effect. The object identification and detection system may be employed to detect and/or track a shape of one or more transparent objects allowing creation of visual effects (e.g., Pepper's Ghost effect, projections) to enhance guest experiences, create enjoyment, or enhance a narrative part of an immersive environment. In this manner, amusement parks or other narrative experiences may be expanded to include visual experiences relating to ordering, purchasing and/or receiving themed refreshments. For example, the object identification and detection system may be capable of determining a characteristic (e.g., shape, volume, etc.) of the transparent objects (e.g., glasses) to provide the system information to produce visual effects for guest enjoyment.

Further, it may be advantageous to couple the object identification and detection system to a special effects system to allow realistic portrayal of visual effects on or near the transparent objects (e.g., surroundings, surfaces, volumes) while the transparent objects are replaced, moved, used in narrative experiences, and the like. However, certain traditional cameras, detectors, and sensors may not reliably track motion and/or provide identification of transparent objects (e.g., glass vessels, plastic vessels). For example, time-of-flight and structured light depth sensors do not accurately detect the shape of transparent objects, such as glass and certain types of plastic, due to the light passing through the transparent material, resulting in distorted reflections or no data. For certain practical effects that use the volumetric shape or outline of the object to be detected and tracked (e.g. in a drink pour tap that implements interactive media elements to create visual effects when the liquid is poured into a glass), detecting such an object reliably using RGB-D cameras is not feasible. Embodiments of the present disclosure provide systems and methods to detect and/or track the characteristics, the shape, and/or a location of the transparent objects, therefore allowing the coordinated special effects to be employed relative to the tracked objects in a more accurate manner to enhance guest experiences. In an embodiment, the object identification and detection system as provided herein may include with an infrared reflectance assembly utilizing reflective properties of the transparent objects to recover characteristics relating to the transparent objects that are fed to one or more post-processing algorithms to classify and track the transparent objects. In some embodiments, the infrared reflectance assembly senses positional data of the transparent object by using point light source illumination (e.g., multiple infrared LEDs) to irradiate the transparent object and detect reflected point sources, which in turn may be used to determine an identity, the shape, and/or the location of the transparent object.

In certain embodiments, the system may include show effects that present virtual or simulated objects that may supplement the appearance of real world objects (e.g., glasses) via a Pepper's Ghost effect. For example, a Pepper's Ghost effect may be used to generate an illusion that a drink is being poured or mixed. Conventionally, a Pepper's Ghost system employs a primary area (e.g., an object, background scene), a secondary area (e.g., augmented reality scene), and an optical beam splitter (e.g., glass, partially reflective film). The optical beam splitter may be arranged to enable transmission of imagery of the primary area through the optical beam splitter. The optical beam splitter may also reflect imagery from the secondary area. As such, the guest may observe imagery from the primary area (e.g., real imagery transmitted from the primary area through the optical beam splitter) and imagery from the secondary area (e.g., virtual imagery reflected from the secondary area off the optical beam splitter) that are combined, superimposed, or overlaid with respect to one another via the optical beam splitter. As such, show effects may realistically portray elements of the secondary area such that a viewer perceives them as physically present in the primary area. Thus, a Pepper's Ghost effect may generate an illusion of a themed character interacting with refreshments as part of a refreshment effect.

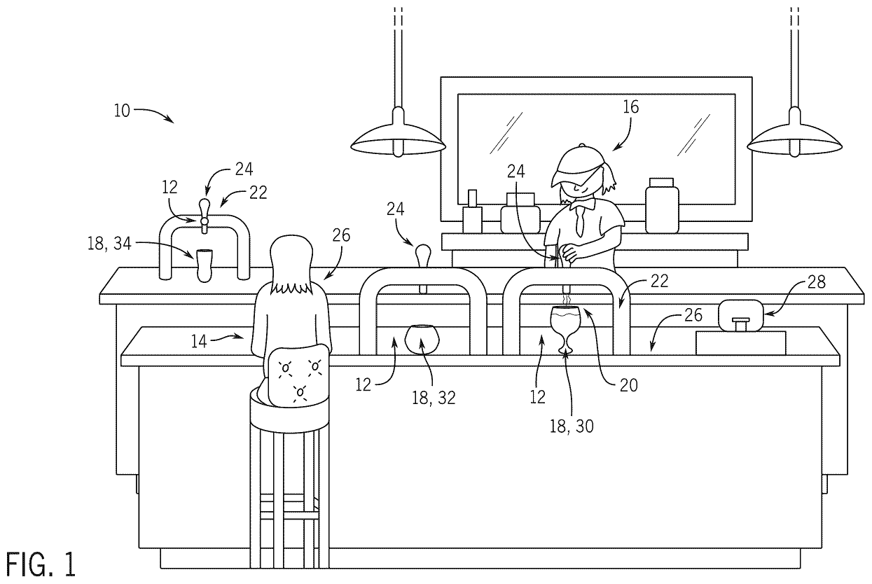

FIG. 1 is a schematic illustration of an entertainment venue of an environment 10. It should be understood that the environment 10 is by way of example, and other contexts for use of the object identification and detection system are also contemplated. The environment 10 may be part of an amusement park or other narrative experience that facilitates guest interaction through the inclusion of visual experiences. The environment 10 may be any restaurant, bar, or other food and/or beverage venue. The environment 10 may be part of a retail experience, an attraction experience, an educational experience, a tourism experience, etc. The environment 10 may include one or more identification and detection systems 12 that may be used in conjunction with or as part of a refreshments (e.g., food and/or beverage) effect.

In the illustrated example, a guest 14 may order, purchase, or receive refreshments from a staff member 16. As such, the staff member 16 may prepare a refreshment (e.g., using an object 18 as an empty or available beverage container) in conjunction with the object identification and detection system 12. The object identification and detection system 12 may identify and may track the object 18 (e.g., transparent object, glass), may determine a characteristic (e.g., shape, height, position, volume, etc.) of the object, and may transmit a signal to a special effect system to activate a special effect 20 (e.g., one or more special effects, visual effect, imagery projection, Pepper's Ghost effect) on or near the object 18. The special effect 20 may enhance the immersive experience of the guest 14 within the environment 10 of the food and beverage venue.

With the foregoing in mind, in some embodiments, the object identification and detection system 12 may include an infrared reflectance assembly that may include a stand 22, a tap handle 24, infrared light sources (e.g., one or more infrared light sources), and sensors (e.g., one or more sensors) may be used to determine the characteristic of the object 18. The stand 22 may be positioned on a surface 26 (e.g., bar, table, cart, stand) and may be positioned in proximity to a point of sale terminal 28. For example, the guest 14 may order the refreshment from the staff member 16 at the point of sale terminal 28. The staff member 16 may select the object 18 associated with the refreshment ordered by the guest 14. In this manner, the guest 14 may order refreshments associated with different cups or glasses 30, 32, 34 of the illustrated embodiment. It is to be noted, that the glasses 30, 32, and 34 serve by way of example and additional or other beverage and/or food container shapes and/or sizes may be used with the object identification and detection system 12.

With the foregoing in mind, in general operation, the staff member 16 may select the object 18 (illustrated as glass 30) associated with the refreshment ordered by the guest 14. The glass 30 may then be positioned within the infrared reflectance assembly of the object identification and detection system 12. The infrared reflectance assembly may activate the light sources and the sensors to illuminate and detect the glass 30. For example, the illustrated selected glass 30 has a goblet shape. The object identification and detection system 12 may detect the shape, size, and/or position of the selected glass 30, which can then may be used as an input to a special effect system to, for example project overlaid media or hologram images (e.g., projected or displayed media) that may correspond to the appropriate shape of the glass 30 For example, the special effect system may generate volumetrically correct special effect content for overlay on or near the object 18 (e.g., including objects of different shapes and/or sizes), e.g., the selected glass 30, as shown by the illustrative embodiment. As such, special effect content appearing as three-dimensional (3D) overlays may be perceived by the guest 14. In this manner, the guest 14 may observe realistic special effects from multiple viewing angles.

As noted, transparent objects 18 may be difficult to resolve using conventional sensors. Thus, while cameras may be disposed within the environment 10, it may be difficult for a camera to precisely map the shape and location of exterior walls of a clear or partially clear object 18. As provided herein, the object identification and detection system 12 may use infrared reflectance from object walls to identify one or more characteristics of the object 18 for using in generating special effects 20. This may provide a more immersive environment, because the staff member 16 may operate naturally, selecting a particular object 18 (e.g., selecting the object from a group of objects having different sizes or shapes based on the sensor data being characteristic of the selected object) that is appropriate for an ordered beverage, and positioning the selected object near or under the preparation area, shown here as including one or more tap handles 24. The special effects system may generate instructions to activate the special effect 20 that is appropriate for the size and shape of the selected object 18. In some cases, the environment 10 may be equipped with a predefined set of different objects 18, such as a beer glass, a wine glass, a champagne flute, and a tumbler. Based on characteristic reflection that is resolvable to distinguish between the different objects 18, a special effect 20 associated with the detected object 18 may be activated. In one example, a hologram of a living creature may be projected to provide an illusion that the creature is inside the object 18. Even when the object 18 is moved relative to the surface 26, the special effect 20 may remain anchored to the position of the object 18 using updated detection information. In another example, a level of a beverage may be selected based on an estimated volume of the object 18, which may be determined using the 360 degree detection of the object walls.

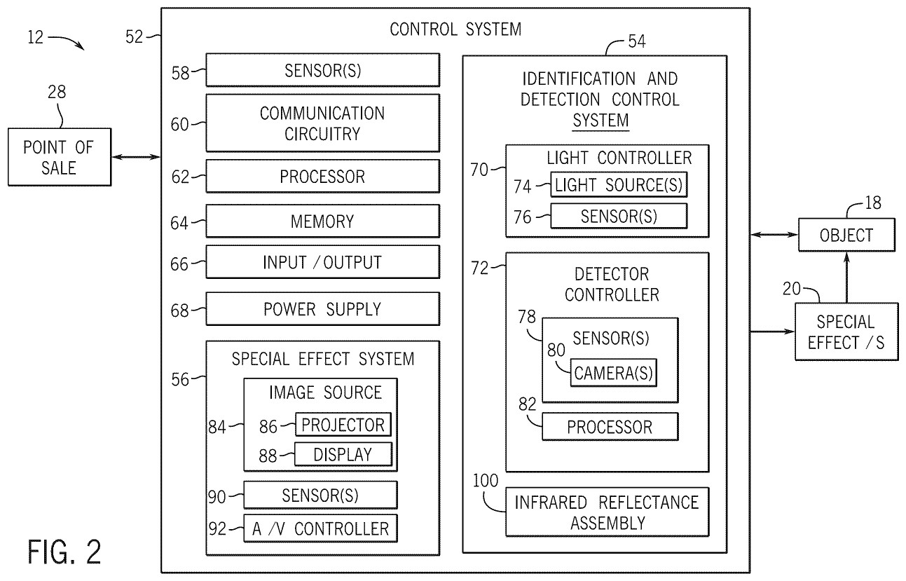

FIG. 2 is a block diagram of the object identification and detection system 12 that may be implemented to detect and/or identify objects 18 in an environment of the present embodiment. The system the object identification and detection system 12 may include a control system 52 including an identification and detection control system 54 and a special effect system 56. The control system 52 may include one or more sensor(s) 58, communication circuitry 60, a processor 62, a memory 64, an input/output (I/O) port 66, a power supply 68 (e.g., wired power, a battery) and the like. The control system 52 may receive sensor data from the sensor(s) 58 (e.g., position sensor, tracking sensor, camera, laser or infrared sensor, etc.).

The communication circuitry 60 may facilitate wired or wireless communication between various components of the control system 52 as well as with external devices, such as the point of sale terminal 28, or central or local controllers of the amusement park or immersive experience. The processor 62 may be any suitable type of computer processor or microprocessor capable of executing computer-executable code. Moreover, the processor 62 may include multiple microprocessors, one or more “general-purpose” microprocessors, one or more special-purpose microprocessors, and/or one or more application specific integrated circuits (ASICS), or some combination thereof. For example, the processor 62 may include one or more than one reduced instruction set (RISC) or complex instruction set (CISC) processors. In some embodiments, the processor 62 may receive inputs transmitted from the point of sale terminal 28 and communicate with the point of sale terminal 28 using the communication circuitry 60. For example, the guest 14 may order the refreshments that are associated with the refreshment effect. As such, the control system 52 may receive communication (e.g., the characteristics, a number of refreshments ordered, a type of refreshment effect) associated with the object 18 from the point of sale terminal. In some instances, the control system 52 may control the object identification and detection system 12 to activate the infrared reflectance assembly.

The memory 64 of the control system 52 may also be used to store the data, various other software applications, and the like that are executed by the processor 62. The memory 64 may represent non-transitory computer-readable media (e.g., any suitable form of memory or storage) that may store the processor-executable code used by the processor 62 to perform various techniques described herein. The I/O ports 66 may be interfaces that may couple to other peripheral components such as input devices (e.g., keyboard, mouse), sensors, input/output (I/O) modules, and the like. The power supply 68 may provide power to one or more components of the control system 52. The components of the control system 52 may be integrated within the food and restaurant venue including in the point of sale terminal 28, a stand (e.g., the stand 22 of FIG. 1) of the infrared reflectance assembly, the surface 26, or any other suitable component of the object identification and detection system 12. As such, the control system 52 may be concealed at least in part from view of the guest 14.

The control system 52 may also include an identification and detection control system 54 that includes a light controller 70 and a detector controller 72. It should be noted, that the light detector 70, the detector controller 72, and one or more additional controllers may include a processor and a memory. The controllers 70, 72 and/or additional controllers may include sensors. Additionally and/or alternatively, the controllers 70, 72 may be communicatively coupled to one or more sensors separate from the controller 70, 72. The light controller 70 may include one or more infrared light sources 74 (e.g., infrared LEDs, single infrared LED, multiple individual LEDs, LED strip, multiple LED strips, laser). In some embodiments, the infrared light sources may produce light at various wavelengths (e.g., 780 nm to 1 mm, 780 nm to 1.4 μm, 1.4 μm to 3 μm, 3 μm to 1 mm). The infrared light sources 74 may be controlled by the light controller 70 to illuminate the object 18. In some embodiments, the infrared light sources 74 may include infrared point light sources (e.g. at least one infrared point light source). As such, the infrared point light sources may be controlled by the light controller 70 to illuminate the object 18. Further, the infrared point light sources may be aligned to generate a gridded LED pattern forming a structured or multidirectional (e.g., 360 degree) light projection. In this manner, the infrared light sources 74 may be controlled by the light controller 70 to generate the gridded LED pattern to facilitate dynamic detection and identification of the object 18. In some instances, the gridded LED pattern may illuminate areas in which the refreshment effect is performed. The structured light projection may be used to determine if the object 18 is located within the infrared reflectance assembly 100 or if no object 18 is present.

In some embodiments, the infrared light sources 74 may include an infrared-backlit display (e.g., LEDs mounted in a housing). The infrared-backlight display may provide uniform lighting (e.g., diffuse output, even illumination, structured light projection) in areas in which the refreshment effect is performed on the object 18. In certain embodiments, combinations of infrared light sources 74 may be used by the identification and detection control system 54. For example, the light controller 70 may activate a first light source (e.g., infrared-backlit display) for initial detection of the object 18. As in, the light source may passively illuminate areas associated with the object 18 using the structure light projection. In this manner, when the identification and detection control system 54 detects the object 18 via the detector controller 72 a second light source (e.g., infrared point light sources) may be activated to actively detect and identify the object 18.

In certain embodiments, the light controller 70 of the identification and detection control system 54 may include one or more sensors 76. In some embodiments, the sensors 76 of the light controller 70 are used to detect information regarding the infrared light sources 74. For example, it may be advantageous for the sensors 76 to detect if the infrared light sources 74 undergo a change (e.g., change of power state, change of intensity, change of alignment) as the infrared light sources 74 are not within wavelength ranges visible by human eye. As such, the sensors 76 may indicate to the identification and detection control system 54 that infrared light sources 74 of the light controller 70 may have experienced change of alignment. In this manner, the identification and detection control system 54 may provide information to the control system 52 of the object identification and detection system 12 to adjust alignment of the infrared light sources 74. Further alignments of the infrared light sources 74 may be directed by the light controller 70 instructed by the processor 62 and/or performed by the staff member 16. In some embodiments, the sensors 76 may indicate to the identification and detection control system 54 that infrared light sources 74 of the light controller 70 may be nearing end of life. As such, the staff member 16 may receive notification to change the infrared light sources 74 to ensure continued function of the identification and detection control system 54.

The identification and detection control system 54 may also include the detector controller 72. In certain embodiments, the detector controller 72 includes one or more sensors 78, one or more cameras 80, a processor 82, and an infrared reflectance assembly 100. The sensors 78 detect light reflected from the object 18 (e.g., illuminated object) and generate sensor data indicative of the reflected light and/or the absence of the reflected light associated with the object 18. The one or more sensors 78 may include the one or more cameras 80, proximity sensors (e.g., passive infrared sensors), single channel detectors, multi-channel detectors, photodiodes (e.g., indium gallium arsenide (InGaAs), silicon, geranium), photodiode arrays, avalanche photodiodes, photovoltaic detectors (e.g., indium lead, indium arsenide lead), photovoltaic detector arrays, thermopile detectors, amplified detectors, single photon counting detectors, quantum cascade photodetectors, Fresnel lens, pyroelectric sensor, or the like. In some embodiments, the one or more sensors 78 of the detector controller 72 are positioned on the stand 22 of FIG. 1 out of sight of the guest 14 and detect the reflected light associated with the object 18 when illuminated.

Further, the detector controller 72 of the identification and detection control system 54 may include cameras 80 (e.g., one or more cameras). The one or more cameras 80 may include infrared cameras (e.g., thermal imager, complementary metal-oxide-semiconductor (CMOS) camera, charge-coupled device (CCD)) positioned on a stand (e.g., the stand 22 of FIG. 1) of the infrared reflectance assembly directed towards areas associated with the object 18. The cameras 80 may image the object 18 and/or reflected light associated with the object 18 in order to generate sensor data. The sensor data may be indicative of the reflected light and/or the absence of the reflected light associated with the object 18. In some embodiments, the cameras 80 may capture a static image and/or a dynamic image (e.g., video) to provide data to the processor 82 of the detector controller 72. In some instances, the cameras 80 image both the light reflections (e.g., an infrared image) and a visible digital image of the surroundings (e.g., RGB image). In this manner, the infrared image and the visible digital image may superimpose multiple images to facilitate active and/or static detection and identification of the object 18.

In some embodiments, the sensor data generated by the one or more sensors 78 may be provided to the processor 82. The processor 82 may recieve the sensor data and determines the characteristic of the object 18 based on the sensor data. The processor 82 may transmits a signal to activate a special effect based on the characteristic. For example, the sensor data (e.g., localization data, tracking data, identification data, object detection data) may provide information about a position of the object 18. In some cases, the object 18 may be in a static position. In this manner, the object 18 may be positioned in the static position while located on a base including an alignment marker. As such, the processor 82 may determine the characteristic (e.g., the position) of the object 18.

In certain embodiments, the sensor data may be indicative of a height, a volume, a shape, a position, and/or an identity associated with the object 18. For example, an infrared photodiode may detect light reflected from the object 18. As such, the infrared photodiode (e.g., photodiode with infrared filter) generates electrical current based on the reflected light detected and provides information to the processor 82. As the light reflected from the object 18 is infrared, the infrared photodiode is able to selectively detect the light reflected from the object 18 reducing interference from non-infrared background lighting. The processor 82 then determines the characteristic of the object 18 such as the height and transmit the signal to the special effect system 56.

With this in mind, the control system 52 of the object identification and detection system 12 may include the special effect system 56. The special effect system 56 may recieve the signal from the control system 52 to activate the special effects system 56 to generate the special effect 20 associated with the object 18. As such, the special effects system 56 controls the image source 84, one or more sensors 90, and an audio/visual (A/V) controller 92 to produce special effects 20. It should be noted, the control system 52 may include the identification and detection control system 54. Additionally and/or alternatively, the identification and detection control system 54 may be separate from the control system 52 and communicatively couple with the control system 52. In some embodiments, the special effect may generate the refreshment effect associated with food and beverage related orders of the guest 14 after the object 18 is detected and identified by the object identification and detection system 12. For example, the special effect system 56 may generate special effects 20 based on a Pepper's Ghost effect. In this manner, the special effect system 56 may include an image source 84 comprised of a projector 86 and a display 88. The projector 86 may be an external projector, an optical projector with a lens, or the like. The projector 86 may present different images at different times controlled by the image source 84, such as to simulate certain movements.

The projector 86 may be mounted to a frame and/or hidden or concealed from the guests 14. The display 88 may be any suitable number of displays and/or any suitable type of display (e.g., liquid crystal display (LCD), light emitting diode (LED) display, organic light emitting diode (OLED) display, micro-LED), projection screen that receives image sources and displays sources as virtual images and/or videos. The display 88 may include multiple displays that collectively produce imagery. The display 88 may also include three-dimensional (3D) displays, such as a volumetric display, a light field display, a stereoscopic display, a lenticular display, and the like. For example, the display 88 may be a television screen that receives image data from the projector 86 and display the image data as imagery. The display 88 may use rear projection in combination with the projector 86 and a transmissive element.

In some embodiments, the special effects system 56 may be used to generate an illusion that a drink is being poured or mixed. For example, a Pepper's Ghost effect may be generated as a special effect. As such, the special effects system 56 may realistically produce special effects 20 on or near the object 18 (e.g., primary area) such that the guest 14 perceives elements projected from the projector 86 (e.g., secondary area) as physically present in on or near the object 18. As such, an optical beam splitter may be arranged to enable transmission of the special effects 20 projected on the display 88 of the image source 84 through the optical beam splitter and reflect imagery (e.g., special effects). In some instances, the special effects system 20 may generate the special effect 20 of the refreshment effect wherein the refreshment effect may include illusions of liquids flowing to the object 18 from a spout, illusions of liquids filling the volume of the object 18, interactions of themed characters on or near the object 18, or the like. For example, the special effects 20 generated by the special effect system 56 may combine, superimpose, or overlay effects with respect to one another on or near the surface of the object 18 to enhance guest experiences.

Further in some embodiments, the special effect 20 may be any suitable 2-dimensional (2D) image output by the projector 86 and/or the display 88. For example, the special effect 20 may be a static image such as a non-changing picture or image. In another example, the special effect 20 may be a dynamic image and/or video that changes over time. In an additional or alternative embodiment, the special effect 20 may include a three-dimensional (3D) image that may be static or dynamic. In an embodiment, the display 88 may include a mechanical object (e.g., a solid object) that when lit by surrounding or integrated lighting creates a reflection (e.g., virtual imagery) on the object 18. The display 88 may be positioned to project the special effect 20 onto the entirety of the object 18, a portion of the object 18, a target location of the object 18, and the like. The special effect 20 may include one or more special effects 20 projected by the display 88 that appear in one or more locations as reflected off the display 88.

In certain embodiments, the special effects system 56 may include an A/V controller 92. For example, the special effects system 56 may control the special effects 20 via the image source 84 to produce illusions on or near the object 18. As such, the special effect system 56 may also generate A/V effects under control of an A/V controller 92 to provide themed sounds, background effects, projection or the like to enhance guest experiences. The A/V controller 92 may include an audio input device (e.g., a microphone), an audio output device (e.g., a speaker), one or more visual output devices (e.g., lights, displays, projectors, etc.), a processor, a memory, or a combination thereof. For example, the A/V controller 92 may control activation of audio recordings, and/or visual displays to enhance the special effects 20 produced by the special effects system 56. As such, audio recordings corresponding to the special effects 20 may be produced to enhance guest experiences in themed environments. In some instances, the A/V controller 92 may activate a voice associated with a character of the themed environment over speakers near the object 18. In this manner, the special effects 20 occurring on or near the object 18 may appear to the guest 14 as resulting from casting of magical spells (e.g., projected from speaker). Further, likeness of the character may be projected in conjunction to the voice by the A/V controller 92 of the special effect system 56.

With the foregoing in mind, the object identification and detection system 12 may include the sensors 78 controlled by the detector controller 72 to detect light from the one or more infrared light sources 74, wherein the light is reflected from the object 18. The reflected light (e.g., infrared light) is detected by the sensor(s) 78 (e.g., infrared camera 80) as the object 18 may be positioned in the camera's field of view. As such, sensor data is generated and provided to the control system 52 that is indicative of the reflected light from the object 18. In some embodiments, the reflected light may be obtained by one camera 80. It should be noted, that alternative embodiments, as discussed herein, may include multiple sensors 78 to collect sensor data indicative of reflected light.

In some embodiments, the sensors 78 may transmit the sensor data to the one or more processors 62, 82 to determine the characteristic of the object based on the sensor data. The sensor data may include extractable patterns and/or recognizable features of the object 18 provided from the reflected light 102. As such, the characteristic associated with the object 18 is determined by the control system 52. In an embodiment, the control system 52 may determine the position and the identity of the object 18 based on the characteristics that include at least the size, the height, and/or the shape of the object 18 as captured by the camera 80. In this manner, the identification and detection control system 54 may directly use the sensor data to determine the characteristic of the object 18 and transmit the signal to activate the special effect system 56 based on the characteristic. For example, the camera 80 may directly image an identification marker positioned on the object 18 itself and provide sensor data to the control encoded with identification information of the object 18 being used in the object identification and detection system 12. In some instances, the identification marker may be an infrared marker, substantially formed from materials invisible at visible wavelength and therefore invisible to the guest 14.

In an embodiment, the point of sale terminal 28 of the object identification and detection system 12 may provide information to the one or more processors 62, 82 of the control system 52 to be used in combination with the sensor data to determine the characteristic of the object 18. As such, the processors 62, 82 determine the characteristic of the object 18 to activate the special effect system 56. For example, the guest 14 may order refreshments associated with the special effects 20 at the point of sale terminal 28. The point of sale terminal 28 may communicate with the control system 52 to provide identification information corresponding to object 18 associated with orders made by the guest 14. In this manner, the control system 52 uses identification information of the object 18 in combination with the sensor data to determine the characteristic of the object. In some instances, identification information may provide identification of the object 18 while the sensor may provide the static position data and/or the dynamic position data associated with the object 18.

In certain embodiments, the sensor data may include post-processing to determine the characteristic of the object 18. As such, in response to receiving the signal from the sensors 78 one or more processors 62, 82 may determine the characteristic before activation of the special effect system 56 by using a post-processing algorithm based on a comparison of the characteristic of the object with historical object data. In some instances, the post-processing algorithm is a machine learning model. As such, the machine learning determines the characteristic of the object 18 using supervised or unsupervised algorithms. For example, in an embodiment, the machine learning may be unsupervised and determine correlations between the sensor data and the characteristics of the object 18. In this manner, the characteristic of the object can be reconstructed within some confidence interval to approximate the volume, the position, and or the shape to allow special effects 20 to be activated.

In certain embodiments, the machine learning may be supervised and include training data. As such, the training data may be based on historical data generated by collecting reflected light from known objects 18 to create a database retrievable by the control system 52. For example, the special effects (e.g., refreshment effect) may include use of a particular empty beverage container (e.g., the object 18) having transparent exterior walls to ensure that activation of the special effect 20 will volumetrically correct imagery with respect to the object 18. With this in mind, the database containing the historical data may include extractable patterns based on the sensor data including recognizable features of the object 18 provided from the reflected light of the particular empty beverage containers. Further, the database containing the historical data may include data of associated with the objects 18 in static positions, dynamic positions, and other arrangements that provide full or partial patterns based on the reflected light in order to train the machine learning model. In some instances, the machine learning algorithm is iteratively trained during operation of the object identification and detection system 12. For example, one or more correlations between the characteristic of the object 18 and the historical data are identified by the machine learning algorithm and used as training data to update the machine learning model.

In some embodiments, the sensor data may be post-processed to determine the characteristic of the object 18. As such, in response to receiving the signal from the sensors 78 one or more processors 62, 82 may determine the characteristic before activation of the special effect system 56 by using a post-processing. The tolerance level associated with detection and identification of the object 18 by the object identification and detection system 12 may be generated based on to use in combination with the post-processing algorithm executed by the processor 62 of the control system 52. The tolerance level is indicative a confidence level of the post-processing algorithm in determining the characteristic of the object as extracted from the sensor data. For example, the confidence level may be related to the characteristic such as the height, the volume, the position and/or the shape. The machine learning model may provide the confidence level based on a percentage (e.g., 80%, 90%, 95%) wherein the percentage is relative to the characteristic (e.g., height, volume, location, shape). As such, the tolerance level may provide parameters to the machine learning model to trigger the special effect system 56 if the tolerance level of the characteristic is above some threshold (e.g., 80%, 90%, 95% confidence).

If the tolerance level is satisfied (e.g., confidence above a threshold) the object identification and detection system 12 may activate the special effects 20. In some embodiments, the tolerance level is not satisfied (e.g., confidence below some threshold) and the special effects 20 are not activated. As such, imagery is not generated on or near the object 18. In some instances, if the tolerance level is not satisfied the control system 52 may notify the staff member 16.

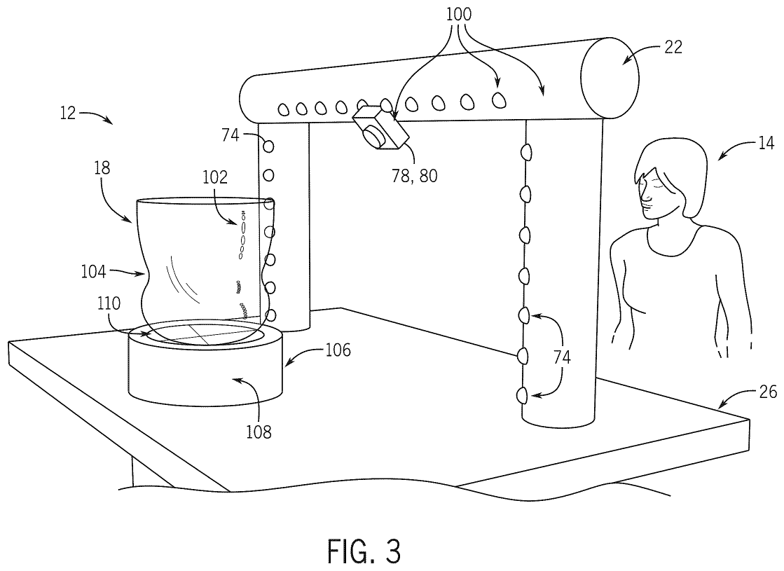

FIG. 3-6C are examples of arrangements of the object identification and detection system 12 or individual components thereof. It should be understood that the disclosed embodiments may include all or some of the disclosed elements of the object identification and detection system 12 of FIG. 2.

FIG. 3 is a schematic illustration of the object identification and detection system 12. The object identification and detection system 12 may include the infrared reflectance assembly 100 designed to identify and detect the characteristic of the object 18 based on the reflected light 102 produced on one or more transparent exterior walls 104 of the object 18. The infrared reflectance assembly 100 may include the stand 22, the one or more infrared light sources 74, and the one or more sensors 78. The object identification and detection system 12 also may include a base 106 in which the object 18 can be placed in a predetermined position. The position may be determined by a location 108 of the base 106 located on the surface 26. The location 108 of the base 106 may be selected to ensure that the object 18 is properly aligned with the infrared reflectance assembly 100 to allow detection and identification of the object 18. The position located on the base 106 may be demarcated with an alignment marker 110 to allow the staff member 16 to place the object 18 in proper alignment during operation of the object identification and detection system 12. As such, position data may be detected by the one or more sensors 78, indicative of the characteristic of the position of the object 18 when the object 18 is located on the alignment marker 110. In certain embodiments, the position of the object 18 may include dynamic positional data. In an embodiment, the base 106 may be coupled to a sensor of the object identification and detection system 12 (e.g., sensor 58, see FIG. 2) that detects placement of the object on the base 106 to activate features of the object identification and detection system 12. In this manner, the infrared light may be activated in response to the object 18 being positioned on the base 106. In an embodiment, the base 106 and the alignment marker 110 may not be included. As such, the object 18 may be detected and tracked by the object identification and detection system 12 while not positioned on the base 106 and/or the alignment marker 110.

In the illustrated embodiment, the object 18 is transparent (e.g., translucent). Further, the object 18, before initiation of the special effect 20, may be an empty beverage container with the one or more transparent exterior walls 104. The transparent exterior walls 104 are at least partially transparent to visible light and at least partially reflective of infrared light. As such, the reflected light 102 reflected from the one or more infrared light sources 74 may be detected by the sensors 78 and the sensor data indicative of reflected light detection is transmitted to the control system 52 to determine the characteristic of the object 18. In certain embodiments, the empty beverage container (e.g., the object 18) may be transparent, wherein “transparent” is defined as allowing visible light (e.g., light having a wavelength in a range of about 380 nm to about 750 nm) to pass through the transparent exterior walls 104 with limited interaction (e.g., loss, absorption, and/or reflection) with a material (e.g., glass, plastic) that forms the transparent exterior walls 104 while generating at least partial reflection of infrared light. In an embodiment, the object 18 may be at least 50% transparent to visible light. As such, the transparent exterior wall 104 may generate reflection of infrared light (e.g., light having a wavelength in a range of about 780 nm to about 71 mm or photons with energies 1.24 meV to 1.58 eV) as the infrared interact with the material that forms the transparent exterior wall 104. It should be noted, that the transparent exterior walls 104 may have various extents of transparency to visible light and/or reflectance of infrared light. For example, the transparent exterior walls 104 may transmit in a range of 75% to 100% of the visible light, while other transparent exterior walls 104 may transmit visible light in a range of 85% to 95%. Further, the transparent exterior walls 104 may reflect 60% to 100% of the emitted infrared light, while other transparent exterior walls 104 may reflect infrared light in a range of 85% to 95%. In this manner, the transparency to visible light and/or reflectance of infrared light may vary based on the material from which the object 18 is made and/or the energy of the infrared light sources 74 used to illuminate the object 18. The extent of transmission and/or reflectance may be determined using rules of geometric optics (e.g., Snell's Law) and the refractive index of the material used to form the transparent exterior walls 104. In an embodiment, the transmission and reflection properties of the transparent exterior walls 104 may be optimized to meet a tolerance level associated with post-processing determination of the characteristic of the object 18 by the object identification and detection system 12.

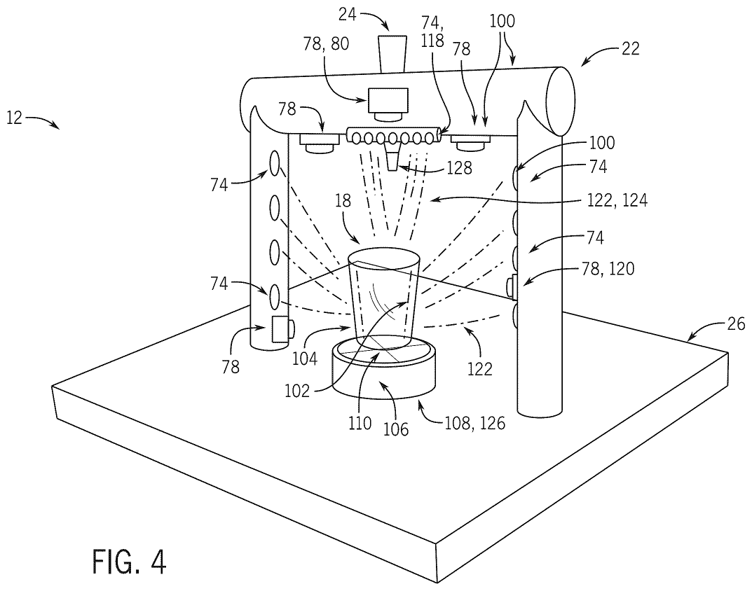

In the illustrated embodiment, the infrared light sources 74 are infrared point sources (e.g., multiple individual LEDs). The infrared light sources 74 are mounted on the stand 22 in a U-shaped formation. As such, the object 18 is illuminated by the infrared light sources 74 on multiple sides (e.g., illuminated from three directions with respect to the object's location). In certain embodiment, the infrared light sources 74 are positioned in an arrangement in which the infrared light sources 74 and the one or more sensors 78 including the camera 80 are positioned out of view of the guests 14. As such, the infrared light sources 74 may be positioned to illuminate the object 18 in a direction facing away from the guest 14. Further, the location 108 of the base 106 is selected to allow illumination of the object 18 when placed on the alignment marker 110 of the base 106 out of sight of the guest 14. In this manner the transparent exterior walls 104 of the object 18 may be illuminated to generate the reflected light 102. It should be noted, that alternative embodiments, as discussed below in regards to FIG. 4, may position the infrared light sources 74 in alternative arrangements within the object identification and detection system 12 and/or include alternative infrared light sources 74.

FIG. 4 is a schematic illustration of the object identification and detection system 12. The object identification and detection system 12 may include the infrared reflectance assembly 100 designed to identify and detect the characteristic of the object 18 based on the reflected light 102 produced on one or more transparent exterior walls 104 of the object 18. The infrared reflectance assembly 100 may include the stand 22, the one or more infrared light sources 74, and the one or more sensors 78. In the illustrated embodiment, the one or more infrared light sources 74 may include infrared point light sources and an infrared LED strip 74, 118. For example, the infrared light sources 74 (e.g., infrared point sources) may be positioned on vertical arms of the stand 22 and positioned to illuminate the object 18 positioned on the base 106 located on the surface 26. Further, the infrared LED strip 74, 118 may be positioned on the horizontal portion of the stand 22 positioned above the object 18.

In certain embodiments, the one or more sensors 78 may be arranged on the stand 22 of the infrared reflectance assembly 100 and include one or more cameras and sensors. For example, the one or more sensors 78 include the camera 80 positioned above the object 18 aligned to monitor the presence and/or absence of the object 18 positioned on the alignment marker 110 of the base 106. Further, additional sensors 78 may also be arranged above the object 18. In this manner, these additional sensors may be photodiodes, photodetectors or other infrared detectors. The one or more sensors 78 may also be positioned at various heights along the stand 22 in order to determine the characteristic of the object such as the shape or a liquid level within the object 18. For example, the sensor 78, 120 may be aligned to monitor the object 18 including the liquid level of the object 18. In this manner, the sensor 78, 120 may determine the object 18 is empty, partially full, or full of liquid based on the change in transmission and reflection of infrared and/or visible light. It should be noted, that FIG. 4 may demonstrate a particular embodiment of the object identification and detection system 12 and that multiple configurations of infrared light sources 74 and sensors 78 may be suitable in order to detect the object 18.

In some embodiments, the infrared light sources 74 of the object identification and detection system 12 may generate a light path 122. The light path is a path (e.g., infrared path not visible to human eyes) that the infrared light from the one or more infrared light sources 74 travel to the transparent exterior walls 104 of the object 18. For example, the light path 122 generated from point infrared light sources may be collimated (e.g., focused to a beam spot) to ensure proper generation of the reflected light 102 used to determine the characteristic of the object 18. As such, the light path 122 may be controlled through alignment of the infrared light sources 74 by the control system 52 and/or the staff member 16. In other embodiments, the light path may be diffuse. For example, the light path 122, 124 of the infrared LED strip may generally illuminate the area in which the object 18 is anticipated to be positioned. In some instances, alternative infrared light sources 74 such as the infrared-backlit display may generate light paths 122 that are diffuse, collimated, and or a combination thereof. In this manner, the light paths 122 produced by the infrared light sources 74 illuminate the object 18 allowing detection of the reflected light 102 by the sensors 78.

With the foregoing in mind, the base 106 and the infrared light sources 74 of the object identification and detection system 12 may be arranged to allow the light paths 122 to interact with the object 18. In some embodiments, the infrared light sources 74 may be adjusted to illuminate the object 18 based on the location 108 of the base 106. In some instances, it may be advantageous, to change the location 108 of the base 106 relative to the infrared light sources 74 of the infrared reflectance assembly 100 to allow for object identification and detection. In the illustrated embodiment of FIG. 4, the location 108, 126 of the base is positioned to in between the infrared reflectance assembly 100. As such, the infrared light sources 74, 118 illuminate the object 18 following the light paths 122, 124 originating from infrared light sources positioned vertically and horizontally with respect to the object 18. In this manner, in some embodiments, it may be advantageous to arrange the base 106 in between the stand 22 of the infrared reflectance assembly 100 to generate illusions during activation of the special effects 20 mimicking flow of simulated fluids from a spout 128 disposed on the tap handle 24 affixed to the stand 22. The spout 128 may be designed to resemble traditional beverage tap (e.g., soda fountain, beer tap, etc.). For example, the special effect system 56, once activated by the object identification and detection system 12, may appear to be pouring fire into the object 18 and the object 18 may appear to the guest 14 to be filled with flaming liquid.

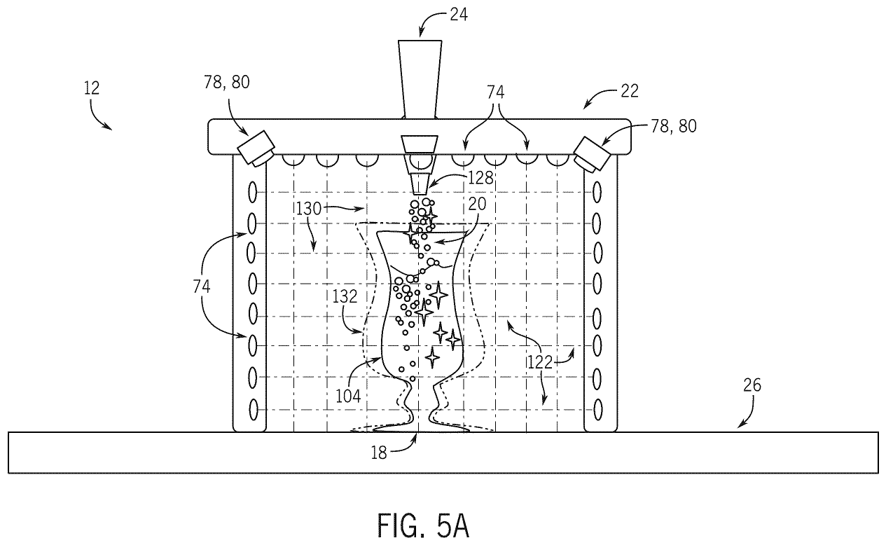

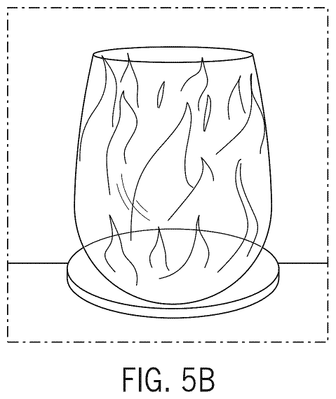

FIG. 5A is a schematic illustration of an embodiment of the object identification and detection system 12 including a gridded LED pattern 130. In one embodiment, infrared light sources 74 (e.g., infrared LED strips, individual arrayed LEDs) are mounted on the stand 22 of the infrared reflectance assembly 100 to illuminate the object 18 generating the light path 122. In the illustrated embodiment the light path 122 generated may be the gridded LED pattern 130. The gridded LED pattern 130 may be formed by positioned the infrared light sources 74 along the stand 22. In certain embodiments, when the object 18 is located within the gridded LED pattern 130 an outline 132 of the object 18 is detected by the sensors 78, 80 (e.g., infrared cameras). The outline may include information about the shape, the position and/or the volume of the object 18 as perturbation (e.g., disruption, generation of reflected light) of the gridded LED pattern 130 may be dynamically tracked by the sensors 78, 80. The outline 132 may be included in the sensor data and is sent to the control system 52 where the post-processing algorithm of the one or more processors 62, 82 determine the characteristic of the object 18 and triggers the activation of the special effect system 56.

In some embodiments, the position of the object 18 may be dynamically tracked to provide dynamic positional data to the control system 52 to facilitate real time determination of the position of the object 18 to enable implementation of realistic special effects. For example, the object 18 may be held by the staff member 16 during generation of the special effects 20. As such, the sensors 78 provide dynamic positional data to the control system 52 based on the reflected light 102 from the transparent exterior walls 104 of the object 18. The control system 52 communicates with the special effect system 56 using the communication circuitry 60 and provides real time dynamic positional data to the special effect system 56. The special effects system 56 may control generation of imagery on or near the surface of the object 18. For example, the staff member 16 may interact with the special effects 20 to enhance the narrative part of the immersive environment. As such, the staff member 16 may mimic putting out fire (e.g., imagery, see FIG. 5B) during the refreshment effect, wherein the staff member 16 moves the position of the object 18 and the special effect system 56 alters the special effect 20 to match a changed location of the object 18. In some instances, the special effect system 56 may control additional A/V effects to accompany the dynamic movement of the object 18.

In certain embodiments, the characteristic of the object 18 (e.g., empty beverage container) may be used to generate the special effect 20 (e.g., volumetrically correct media content) for overlay on the object 18. The special effect system 56 may recieve the signal from the control system 52 indicative of the characteristic of the object 18. The control system 52 may use the one or more processors 62 determines a selection of the special effects 20 that corresponds with the object 18 detected by the identification and detection control system 54. The special effect 20 may be generated based on the selection of the special effect system 56 and generates imagery on or near the object 18. In some embodiments, the special effect 20 may create imagery that generates illusions of fluid flowing from the spout 128 of the tap handle 24 into the object 18. For example, fantastical effects may appear to flow near and/or on the object 18.

In certain embodiments, the generation of the special effects (e.g., refreshment effect) may be achieved using the special effects system 56. In this manner, the beam splitter or other depth-correct display configurations may be used to generate imagery. In some instances, the image source 84 of the special effect system 56 may be reflected off of the beam splitter and directed on or near the surface of the object 18. For example, a volumetric and/or a light field display is used to render volumetrically and stereoscopically correct media and the projector 86 uses projection mapping to illuminate the object 18 and/or areas near the object 18 (e.g., provide projected and/or displayed media). Further, imagery may be optically combined with elements (e.g., A/V elements, background elements, elements associated with the object) by the beam splitter or aerial imaging methods.

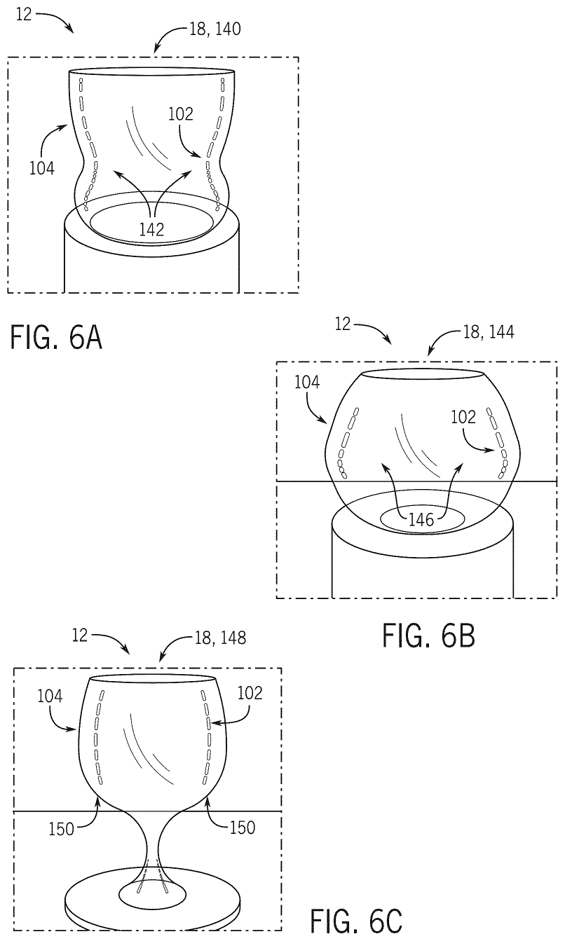

FIG. 6A is a schematic illustration of patterns of reflected light 102 from an object 18, 140. The embodiment disclosed herein, may illustrate a pattern of reflected light 102, 142 of the object 18, 140 that may be used to detect and determine the characteristic (e.g., a shape) of the object 18, 140. For example, properties (e.g., angles, exterior wall thickness, refractive index, transmittance, transmission, etc.) of the transparent exterior walls 104 of the object 18, 140 are characteristic of the reflected light 102, 142 detected by the sensors 78. As such, the sensors 78 (e.g., camera 80) may directly determine the shape of the object 18 after illumination. In some embodiments, the post-processing algorithm may use patterns of the reflected light 102, 142 to determine the characteristic of the object 18 in combination with training data, historical data and/or other suitable comparisons to determine correlations of received sensor data. For example, the hourglass reflected light pattern 142 of the illustrated object 18, 140 in FIG. 6A may be distinguishable from a curvature in a reflected light pattern 146 of the transparent exterior walls 104 of the object 18, 144 in FIG. 6B, which may be associated with a shape similar to a fish bowl. FIG. 6C shows an object 18, 148 with a reflected light pattern 150 having a shape (e.g., curvature) that is distinguishable from other reflected light patterns 142, 146 of other objects 140, 144. As such, in some embodiments, the post-processing algorithm may use the historical data based on the database built from training of the machine learning model to determine the characteristic of (e.g., to identify) the object 18 and activate the special effect system 56.

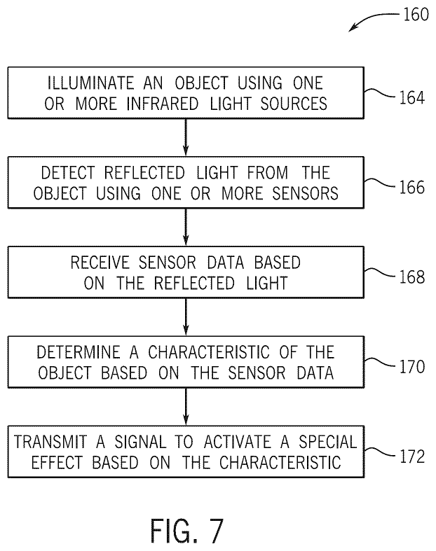

FIG. 7 is a process flow diagram illustrating an embodiment of a method 160 of operating the object identification and detection system 12 and with reference to the preceding figures. The method 160 may include, at block 164, controlling the infrared light sources 74 illuminate the object 18 (e.g., generating the light path 122). At block 166, the one or more sensors 78 detect the reflected light 102 of the object 18. At block 168, the control system 52 receives sensor data based on the reflected light 102 detected by the one or more sensors 78. At block 170, the control system 52 may determine the characteristic of the object based on the sensor data. In some embodiments, the control system 52 uses the post-processing algorithm to determine the characteristic of the object 18. In an embodiment, the post-processing algorithm is the machine learning model that may be trained using historical data stored in the database retrievable by the control system 52. At block 172, the control system 52 transmit a signal to activate the special effect 20 controlled by the special effect system 56. The signal from the control system 52 includes information regarding the special effect 20. In some embodiments, the special effect system 56 selects the special effect 20 associated with the object detected by the sensors 78 and the characteristic determined by the control system 52. As such the special effect 20 generates imagery on or near the object to enhance guests experiences in the food and beverage venue.

While only certain features of the disclosed technology have been illustrated and described herein, many modifications and changes will occur to those skilled in the art. It is, therefore, to be understood that the appended claims are intended to cover all such modifications and changes as fall within the true spirit of the disclosure. Furthermore, although the steps of the disclosed flowchart/s are shown in a given order, in certain embodiments, the depicted steps may be reordered, altered, deleted, and/or occur simultaneously.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An object identification and detection system, comprising:
an infrared reflectance assembly comprising:
one or more infrared light sources configured to illuminate an object; and
one or more sensors configured to detect light from the one or more infrared light sources and to generate sensor data indicative of the reflected light, wherein the light is reflected from the object; and
a control system, wherein the control system is coupled to the infrared reflectance assembly, and wherein the control system is configured to:
control the one or more infrared light sources to illuminate the object;
receive the sensor data from the one or more sensors;
determine a characteristic of the object based on the sensor data; and
transmit a signal to activate a special effect based on the characteristic.

2. The object identification and detection system of claim 1, wherein the one or more sensors comprise an infrared camera.

3. The object identification and detection system of claim 1, wherein the object is transparent to visible light.

4. The object identification and detection system of claim 1, wherein the object is an empty beverage container having exterior walls transparent to visible light.

5. The object identification and detection system of claim 4, wherein the exterior walls are at least partially transparent to visible light and at least partially reflective of infrared light.

6. The object identification and detection system of claim 4, wherein the light reflected from the object is reflected from the exterior walls of the object, and wherein the light reflected from the object is infrared light.

7. The object identification and detection system of claim 1, wherein the infrared light sources are disposed on a stand, and wherein the stand is positioned on a surface.

8. The object identification and detection system of claim 7, wherein the infrared light sources disposed on the stand comprise at least one infrared point light source, one or more LED strips, a gridded LED pattern, an infrared-backlit display, or a combination thereof.

9. The object identification and detection system of claim 1, wherein the special effect is projected to overlay the object.

10. The object identification and detection system of claim 1, wherein the one or more infrared light sources illuminate the object with a structured light projection, and wherein the one or more sensors detect perturbation of the structured light projection.

11. The object identification and detection system of claim 1, wherein the characteristic of the object comprises:
a height, a volume, a shape, a position, an identity, or a combination thereof.

12. A method of operating an object identification and detection system, the method comprising:
controlling, via a control system, one or more infrared light sources to illuminate an object;
detecting, via one or more sensors, light reflected from the illuminated object;
receiving, via the control system, sensor data from the one or more sensors;
determining, via the control system, a characteristic of the object based on the sensor data; and
transmitting, via the control system, a signal to activate a special effect based on the characteristic.

13. The method of claim 12, wherein the special effect comprises projected or displayed media overlaid on the object.

14. The method of claim 12, comprising;
receiving, via a special effects system, the signal to activate the special effect based on the characteristic;
in response to receiving the signal, selecting, via one or more processors, the special effect based on the characteristic of the object; and
generating, via the special effects system, imagery of the special effect on or near the object.

15. The method of claim 14, wherein determining the characteristic of the object based on the sensor data comprises selecting the object from a group of objects having different sizes or shapes based on the sensor data being characteristic of the selected object.

16. The method of claim 14, wherein determining the characteristic of the object uses a machine learning model, wherein one or more correlations between the characteristic of the object and historical object data are identified by the machine learning algorithm, and wherein the one or more correlations are used as training data to update the machine learning model.

17. An object identification and detection system, comprising:
an infrared reflectance assembly comprising:
one or more infrared light sources configured to illuminate an object; and
one or more sensors configured to detect light from the one or more infrared light sources and to generate sensor data indicative of the reflected light, wherein the light is reflected from the object;
a control system, wherein the control system is coupled to the infrared reflectance assembly, and wherein the control system is configured to:
control the one or more infrared light sources to illuminate a transparent object;
receive the sensor data from the one or more sensors;
determine a characteristic of the object based on the sensor data; and
transmit a signal to activate a special effect; and
a special effect system, wherein the special effect system is configured to:
receive the signal from the control system coupled to the infrared reflectance assembly;
select, via one or more processors, the special effect; and
activate the special effect based on the selection, wherein the special effect comprises imagery generated on or near the object.

18. The object identification and detection system of claim 17, wherein the special effect is a Pepper's Ghost effect.

19. The object identification and detection system of claim 17, wherein the object is a beverage container having exterior walls at least partially transparent to visible light and at least partially reflective of infrared light.

20. The object identification and detection system of claim 17, wherein the infrared light sources are disposed on a stand in a U-shaped formation, and wherein the infrared light sources illuminate the object on multiple sides of the object.
